(19) United States
(12) Patent Application Publication
(10) Pub. No.: US 2024/0140259 A1
(43) Pub. Date: May 2, 2024

(54) SYSTEMS AND METHODS FOR REDUCING BRAKE PARTICULATE EMISSIONS AND BATTERY THROUGHPUT

(71) Applicant: Ford Global Technologies, LLC, Dearborn, MI (US)

(72) Inventors: David Cox, London (GB); Shane Keilthy, Chelmsford (GB); Paul Nigel Turner, Chelmsford (GB); Frederik De Smet, Zonhoven (BE); Mario Balenovic, Noord Brabant (NL); Themi Petridis, Bishop's Stortford (GB)

(21) Appl. No.: 17/979,219

(22) Filed: Nov. 2, 2022

(51) Int. Cl. B60L 58/15; B60L 1/00; B60L 7/10

(52) U.S. Cl. CPC B60L 58/15; B60L 1/00; B60L 7/10; B60L 2240/54

(57) ABSTRACT

Methods and systems are provided to control a regenerative braking system comprising a battery, e.g., of a vehicle. The regenerative braking system harvests energy from a braking event. The energy can be stored in the battery, used to power a plurality of devices in the vehicle, or the battery can be preconditioned to provide more capacity to account for a braking event. The vehicle system may comprise one or more electrical loads configured to use power from the battery. The method comprises detecting a regenerative braking event of the vehicle and activating a first electrical load to consume the energy from the regenerative braking event.

### FIELD OF INVENTION

The present disclosure relates to systems and methods for reducing brake particulate emissions, more particularly, but not exclusively, to systems and methods for reducing battery ageing and throughput when activating regenerative braking techniques.

### BACKGROUND

Through new regulations, for example EU7 emissions legislation, the need for reduced brake particulate emissions has led manufacturers to utilize other braking mechanisms, such as regenerative braking. The proposed limits for passenger and light commercial vehicles are likely to result in a requirement to reduce the friction particulate matter from brake wear by 40-60%. It is anticipated that a similar limit-based requirement will be introduced for heavier commercial vehicles. In some jurisdictions, this is the first-time friction brake emissions will be regulated as these emissions now form a significant part of overall vehicle emissions due to advances in exhaust pipe emission reduction technology in the past 20-30 years.

Such regulations will be applicable to all vehicles that fall under, for example EU7, including non-hybrid, hybrids (e.g., mHEV, FHEV and PHEV) and Electric Vehicles (EVs). However, each classification of vehicle has an engineering constraint as a function of the system operation and/or its design, which means satisfying the proposed friction brakes requirements require a different approach across various use cases. For example, one solution is to utilize regenerative braking to reduce/minimize friction brake use and thus the emissions from the braking system (e.g., brake pads and brake discs). In parallel, the other requirements from local jurisdictions must continue to be adhered to, for example the tailpipe emissions for vehicles with a combustion engine (ICE). Furthermore, current technologies used to satisfy emissions standards, such as Electric Exhaust Gas Heater (eEGH) and the hybrid system required to support eEGH power demand, is likely to become standardized on all vehicle with ICEs, irrespective of the degree of hybridization.

In some hybrid applications, such as an mHEV with a low capacity battery, the tailpipe and brakes emissions requirements are in conflict. A new battery system, with price and package implications, may be required to guarantee support of both tailpipe and friction brake emissions requirements if a new strategy can't be achieved, especially for mHEVs. PHEVs and EV applications will experience degraded regenerative braking when battery state of charge is over approximately 90%, or at high SOC (e.g., greater than 85%) which may not satisfy brakes emissions requirements during the start of a trip after a full charge. While limit battery conditions, including battery age may also result in degraded regenerative braking support over vehicle life.

### SUMMARY

Therefore, there is a desire for a strategy to activate/deploy systems (in isolation or a combination of systems) to increase or maintain the regenerative braking power/energy consumptions, mitigating the constraints of a battery-based energy storage system, for the specific requirement of managing (i.e., minimizing or reducing) particulate emissions from the friction brakes.

According to examples in accordance with an aspect of the disclosure, there is provided with a method of controlling a regenerative braking system, e.g., of a vehicle. The regenerative braking system may store harvested energy from a braking event in the battery or use it immediately by activating one or more electrical loads. The harvested energy can be used to power a plurality of devices in the vehicle, such as high voltage loads or low voltage loads, as will be described in more detail below. For example, the vehicle system may comprise one or more electrical loads (i.e., electrical components) configured to use power from the battery, e.g., supply the 12V system and its components including heated seats, heated windshield, or electronic exhaust gas heaters, and the like. The method comprises detecting a regenerative braking event of the vehicle, and activating a first electrical load to consume the energy from the regenerative braking event. The activation of the regenerative braking system may be referred to as a braking event, e.g., the driver of the vehicle pressing the brake pedal or the vehicle activating an automatic emergency braking (an “active braking event”), or the driver lifts off the pedal, does not apply the brakes, but the system still applies a negative torque and harvests energy via regenerative braking (a “passive braking event”), albeit to a lesser extent.

In some examples, the vehicle comprises a battery, the method comprising detecting a surplus of energy from the regenerative braking event; and storing the surplus energy in the battery. In some examples, after the regenerative braking event, the method further comprises reactivating the first electrical load to consume energy from the battery. In some examples, the storing and consumption of the energy from the regenerative braking event occur simultaneously. In some examples, the method further comprises detecting that the battery state of charge is above a first threshold level and activating a first electrical load prior to activation of the regenerative braking system to reduce the battery state of charge below the first threshold level. In some examples, the method further comprises deactivating the first electrical load when the battery state of charge reaches a second threshold level, the second threshold level lower than the first threshold level. In some examples, the difference between the first and second threshold provides capacity for an expected regenerative braking event. In some examples, the method further comprises detecting a trigger event to activate the first electrical load prior to activation of the regenerative braking system; wherein the trigger event is one or more of a smart phone application used to wake up the vehicle, the detection of a key in proximity, or based on the anticipated start of a trip from prior user data, or a predetermined set time

In some examples, the first electrical load is one or more of: an electronic exhaust gas heating element, a low-voltage battery system, 12V system loads, e.g., a seat heating element, a windscreen heating element, an air conditioning system, an air compressor, a water pump, a DC to AC external power system, a positive temperature coefficient heater (PTC), or an infotainment system. A positive temperature coefficient heater is used to heat up the coolant system to condition the motor/battery when cold or to heat the vehicle cabin or for climate control in general. PTCs heaters may be in water or air, however this is important as potentially more energy can be consumed by a PTC heater in water (e.g., coolant circuit) than via the exhaust heater (specific heat capacity of water is greater than exhaust ‘flow’). In some examples, the energy generated through regenerative braking is directly consumed through the activated loads and not stored in the vehicle battery, in this way the battery throughput is minimized.

In some examples, the method further comprises detecting an activation of the regenerative braking system and, in response to detecting activation of the regenerative braking system, increasing the electrical load. In some examples, increasing the amount of electrical load comprises activating a second electrical load. In some examples, the first and second electrical load are activated at the same time. In some examples, the second electrical load is one or more low voltage, or high voltage, components. The low voltage and high voltage components may be one or more of: a first motor, or a second motor with a lower power output than the first motor, an electronic exhaust gas heating element, a low-voltage system, a seat heating element, a windscreen heating element, an electronic catalyst, an air conditioning system, an air compressor, a water pump, a DC to AC external power system, a positive temperature coefficient heater (PTC), or an infotainment system.

In some examples, the method further comprises activating the first electrical load while the vehicle is parked, charging, or while in motion. In particular, it is desirable that the demand of the first load meets or exceeds the harvested energy from the regenerative braking system during the regenerative braking event.

In some examples, the method further comprises activating the first electrical load in response to a user-determined charge completion time or a user-determined state of charge target.

In some examples, the method further comprising predicting a regenerative braking event of the vehicle. In some examples, the prediction is based on one or more of: vehicle data; navigation data; GPS data; ADAS (Advanced Driver Assistance Systems); traffic sign recognition; cruise control system; driver inputs; or historic route information. For example, it may be determined that speed of the vehicle will remain constant, because the user is on a motorway at cruising speed with no traffic. However, a braking event is likely shortly thereafter due to the user's navigation data indication they should exit at the next junction, therefore, activating an electrical load to remove energy from the battery in order to ensure the energy recovered via the regenerative braking can be stored in the battery.

In some examples, the predicting is further based on a driving mode of the vehicle. The driving mode being one of electric propulsion; combustion engine propulsion; one pedal driving operation mode, or a combination thereof, e.g., a hybrid power unit with one pedal driving activated. For example, the engine start-up procedure may be altered based on one or more contextual factors and/or one or more operational parameters.

In some examples, the method further comprises determining an amount of particulate matter of a particulate filter in an after-treatment system of the vehicle is above a threshold; and in response to predicting that there will be a braking event, activating a regeneration process of the particulate filter.

According to a second example in accordance with an aspect of the disclosure, there is provided a regenerative braking system of a vehicle. The regenerative braking system comprising: a first electrical load electrically coupled to the regenerative braking system; control circuitry communicatively coupled to the first electrical load and the regenerative braking system, the control circuitry configured to: detect a regenerative braking event of the vehicle; and activate the first electrical to consume energy from the regenerative braking event.

The regenerative braking system may also comprise a battery, and the control circuitry may be configured to detect that the battery state of charge is above a first threshold level, and activate the first electrical load prior to activation of the regenerative braking system to reduce the battery state of charge below the first threshold level. In some examples, the control circuitry is further configured to: detect a trigger event to activate the first electrical load prior to activation of the regenerative braking system; wherein the trigger event is one or more of a smart phone application used to wake up the vehicle, the detection of a key in proximity, or based on the anticipated start of a trip from prior user data, or a predetermined set time

In some examples, when the regenerative braking system further comprises a battery communicatively coupled to the control circuitry, the control circuitry further configured to: detect a surplus of energy from the regenerative braking event; and store the surplus energy in the battery. In some examples, the control circuitry is further configured to, after the regenerative braking event, reactivate the first electrical load to consume energy from the battery.

In some examples, the control circuitry is further configured to deactivate the first electrical load when the battery state of charge reaches a second threshold level, the second threshold level lower than the first threshold level. In some examples, the difference between the first and second threshold provides capacity for an expected regenerative braking event.

In some examples, the first electrical load is one or more of: an electronic exhaust gas heating element, a low-voltage system, a seat heating element, a windscreen heating element, an air conditioning system, an air compressor, a water pump, a DC to AC external power system, Positive Temperature Coefficient Heater, or an infotainment system. In particular, it is desirable that the demand of the first load meets or exceeds the harvested energy from the regenerative braking system during the regenerative braking event.

In some examples, the control circuitry is further configured to detect an activation of the regenerative braking system and, in response to detecting the activation of the regenerative braking system, increasing the electrical load. In some examples the control circuitry is further configured to activate a second electrical load. In some examples the control circuitry is further configured to activate the first and second electrical load at the same time. In some examples, the second electrical load is one or more of: a first motor, a low voltage battery system, or a second motor with a lower power output than the first motor, an electronic exhaust gas heating element, a low-voltage battery system, a seat heating element, a windscreen heating element, an electronic catalyst, an air conditioning system, an air compressor, a water pump, a DC to AC external power system, a Positive Temperature Coefficient, or an infotainment system.

In some examples, the control circuitry is further configured to activate the first electrical load while the vehicle is parked, charging, or while in motion.

In some examples, the control circuitry is further configured to activate the first electrical load while in response to a user determined charge completion time or a user determined charge completion state of charge target.

In some examples, the vehicle may comprise a particulate filter, such as a diesel particulate filter or a gasoline particulate filter that is a part of the vehicle's after-treatment system. Such filters require regeneration, which typically requires heating up the after-treatment system to a higher than normal operating temperature. Accordingly, in some examples, the regeneration process may be initiated in response to predicting that there will be a braking event. For example, if the amount of particular matter within the after-treatment system is determined to be above a threshold and a regeneration process is required, the after-treatment system can wait until a prediction that a braking event will be made by the driver and then the eEGH can be activated to regenerate the after-treatment filters (e.g., the GPF). Thus, in a system such as that presently required, activating the eEGH more than other electrical loads may be favoured to ensure that the DPF is regenerated and in optimal condition.

According to a third example in accordance with an aspect of the disclosure, there is provided a vehicle. The vehicle comprises a regenerative braking system. The regenerative braking system may store harvested energy from a braking event in the battery, or alternatively activate an electrical load to consume the harvested energy. The harvested energy can be used to power a plurality of devices in the vehicle, directly or after being initially stored in the battery. For example, the vehicle system may further comprise one or more electrical loads (i.e., electrical components) configured to use the harvested power, e.g., heated seats, heated windshield, electronic exhaust gas heaters, and the like. In a particular example, the vehicle comprises a regenerative braking system comprising: a battery; a first electrical load, electrically coupled to the battery; and control circuitry communicatively coupled to the first electrical load and the battery, the control circuitry configured to: detect that the battery state of charge is above a first threshold level; and activate the first electrical load prior to activation of the regenerative braking system to reduce the battery state of charge below the first threshold level.

According to a fourth example in accordance with an aspect of the disclosure, there is provided with a non-transitory computer-readable medium having instructions encoded thereon for carrying out a method of controlling a regenerative braking system. The instructions, when executed, carry out the method. The method comprises detecting a regenerative braking event of the vehicle and activating a first electrical load to consume the energy from the regenerative braking event. The regenerative braking system may also comprise a battery, and the method may further comprise detecting that the battery state of charge is above a first threshold level, and activating the first electrical load prior to activation of the regenerative braking system to reduce the battery state of charge below the first threshold level.

The proposed solution provides improved battery durability (less cycling and thus less ageing); gives commercial vehicles/heavier vehicles more robust support of brake emissions legislation, i.e., not solely dependent on the battery; battery capacity is reduced, i.e., there is less need for a greater capacity battery to satisfy both tailpipe and friction brake emissions (beneficial for pricings, package and weight); and, for some applications, another electrical store/device may be used, replacing the battery, e.g., a capacitor, to yield a ‘low priced system’.

Moreover, it should be noted that no additional hardware is required to achieve the present strategy, as majority of the components are already part of the vehicles as described. Therefore, an over-the-air update could be implemented to implement these control strategies and methodologies on vehicles already sold/deployed in a fleet. However, to achieve synchronisation of the load to the regeneration requirement the components may need to be controlled via a DCDC converter.

A particular advantage of the solutions herein is that the driver is not in the control strategy loop. For example, a DCDC can be requested to modulate the voltage supplied to an electronic exhaust gas heater (eEGH) based on input from the Powertrain Control Module (PCM). Moreover, the eEGH deployment will increase the aftertreatment temperature, which in typical regeneration use cases, may be required to maintain emissions. For instance, when travelling downhill, the engine load is expected to be low and therefore additional thermal energy may be required from the eEGH to maintain the target aftertreatment temperature (˜250° C.) and thus emissions. Conversely, when travelling uphill, engine demand is expected to be great and therefore no additional energy is typically required from the eEGH, the present control strategy would activation of the eEGH at this time to reduce the energy stored to anticipate activation of the regenerative braking system on a next downhill segment. The present disclosure also seeks to circumvent maintaining a high SOC state in the battery, as this is detrimental to battery ageing and throughput; in particular, the activation of electrical loads to spend harvested energy from a regenerative braking system will prevent the battery maintaining high SOC state.

Whilst the benefits of the systems and method may be described by reference to hybrid vehicles, it is understood that the benefits of the present disclosure are not limited to such types of vehicle, and may also apply to other types of vehicles, such as forklifts, trucks, buses, locomotives, motorcycles, aircraft and watercraft, and/or non-vehicle based systems that utilize a catalytic converter, such as electrical generators, mining equipment, stoves, and gas heaters.

These examples and other aspects of the disclosure will be apparent and elucidated with reference to the example(s) described hereinafter. It should also be appreciated that particular combinations of the various examples and features described above and below are often illustrative and any other possible combination of such examples and features are also intended, notwithstanding those combinations that are clearly intended as mutually exclusive.

### BRIEF DESCRIPTION OF THE DRAWINGS

The above and other objects and advantages of the disclosures herein will be apparent upon consideration of the following detailed description, taken in conjunction with the accompanying drawings, in which:

FIG. 1 illustrates an example flow chart of a method of controlling a regenerative braking system comprising a battery, in accordance with at least one of the examples described herein;

FIG. 2 illustrates an example flow chart of a method of providing heat to a catalyst of an after-treatment system, in accordance with at least one of the examples described herein;

FIGS. 3A to 3D illustrate brake application and the resulting electric load and battery state of charge without the teachings of the present disclosure, in accordance with at least one of the examples described herein;

FIGS. 4A to 4D illustrate brake application and the resulting electric load and battery state of charge with the teachings of the present disclosure, in accordance with at least one of the examples described herein;

FIG. 5 illustrates an example flow chart of a method of predicting an activation of the regenerative braking system, in accordance with at least one of the examples described herein;

FIG. 6 illustrates an example flow chart of a method of actions to be taken when an activation of the regenerative braking system, in accordance with at least one of the examples described herein;

FIG. 7 illustrates an exemplary exhaust system comprising an after-treatment system, in accordance with at least one of the examples described herein;

FIG. 8 illustrates a vehicle comprising an engine and an exemplary exhaust system, in accordance with at least one of the examples described herein; and

FIG. 9 illustrates a block diagram of a computing module, in accordance with some embodiments of the disclosure.

### DETAILED DESCRIPTION

It should be understood that the detailed description and specific examples herein while indicating exemplary embodiments, are intended for purposes of illustration only and are not intended to limit the scope of the disclosure. These and other features, aspects, and advantages of the present disclosure will become better understood from the following description, appended claims, and accompanying drawings. It should be understood that the Figures are merely schematic and are not drawn to scale. It should also be understood that the same or similar reference numerals are used throughout the Figures to indicate the same or similar parts.

As discussed briefly above, current regulations on emissions standards are requiring manufacturers to reduce the particulate matter from brake systems that they employ on their vehicle platforms. The regulations are expected to apply to all vehicles. In particular, the vehicle may be a hybrid vehicle, such as a Hybrid Electric Vehicle (HEV), a Plug-in Hybrid Electric Vehicle (PHEV), a Mild Hybrid Electric Vehicle (mHEV), Fuel Cell Electric Vehicles (FCEV), or any other vehicle having an engine and an electrified powertrain; or, any other type of Electric Vehicle (EV). Typically, hybrid vehicles use two or more distinct types of means to store energy, such as batteries to store electrical energy and gasoline/diesel to store chemical energy. The basic principle of hybrid vehicles is that the different types of motors have diverse efficiencies under different conditions, such as top speed, torque, or acceleration and therefore switching from one type of motor to another yields greater efficiencies than either one could have their own. However, as mentioned in the summary section, each classification of vehicle has an engineering constraint as a function of the system operation and/or its design. This means satisfying the proposed friction brakes requirement requires a different approach across various use cases. Put simply, applying regenerative braking solutions to reduce brake pad and brake disc wear would cause other issues such as battery throughput, increased energy capacity requirements, and increased energy consumption; which applies to all vehicles with a regenerative braking system; electric, hybrid, or otherwise.

By way of example, with regards to mHEV applications (and also FHEVs, to a certain degree), the battery may not have the capacity to satisfy both the eEGH use cases (i.e., to satisfy tailpipe emissions) and regenerative braking to reduce friction brake use (i.e., to satisfy new particulate brake emissions legislation). However, sizing the battery to support both the tailpipe and brake emissions, will result in increased battery capacity and price, there is a desire to minimize battery use as much as possible, so traditional hybrid functions (such as regenerative braking) and support of the eEGH may be a menace for battery durability. An increased capacity battery may be required for the capability to support both tailpipe and brake emission requirements but also to maintain battery durability due to increased throughput/usage. There will also be an increase in battery volume, impacting packaging requirements/restrictions, for example, it may not be possible to package a larger battery in some applications. There will also be an increase in battery throughput & durability; emissions requirements include a requirement to be emissions durable to for a number of years (e.g., 15 years), and battery life is typically shorter (e.g., 10 years).

Additional throughput will age the battery, degrading performance and limiting its emissions capability. i.e., the EU7 requirement for durability is more challenging, irrespective of the brake emissions support/reliance. This can be resolved by directly consuming the recuperated energy, without storing in the battery first. Furthermore, an increase in cooling requirements; to guarantee battery availability to support regeneration, it may need to be liquid cooled to mitigate thermal derating (i.e., thermally restricting performance) and a Low Temperature Radiator cooling circuit is not available on all vehicle applications.

Crucially, to satisfy the eEGH power requirements the strategy for an mHEV battery may be to maintain high SOC in preparation for the next start, specifically for an mHEV low-capacity battery. However, this means there is no spare battery capacity to support regenerative braking to minimize friction brake use. In this application, the tailpipe and brakes emissions requirements are incompatible and there is likely to be many use cases in which regenerative braking to facilitate a reduction of friction brake use is not guaranteed.

To condition the battery in preparation for the start of a trip, wherein the battery is at a high SOC, a novel control strategy is required. In particular, the strategy may comprise spending the energy by conditioning the battery, motor temperatures, cabin temperature, or the like based on a trigger event. For example, a trigger event may be one or more of a smart phone application used to wake up the vehicle, the detection of a key in proximity, or based on the anticipated start of a trip from prior user data, or even a predetermined set time.

With regards to plug-in vehicles (e.g., Plug in Hybrid Electric Vehicles, PHEVs, or Electric Vehicles (EVs)), towards the high threshold/limit of battery capacity, i.e., typically >90% state of charge (SOC), the battery charging capacity is significantly reduced to protect the battery and system. Thus, if a vehicle is left on charge overnight, during the first trip of the next day the regenerative braking support may be limited, which means that more power from the friction brake system may be required to support the desired reduction in vehicle speed. This will be a common occurrence for customers who charge at home or at a depot overnight. A product of this is an increased amount of friction brake emissions, which may be problematic in terms of satisfying friction brake emissions requirements. When the battery SOC is towards the upper threshold of the state of charge, regenerative braking capability to facilitate a reduction of friction brake use (thus less emissions) will be degraded in comparison to the capability of the battery at a nominal SOC and a new strategy is required to support this use case.

By way of example, with regards to commercial vehicle applications, the heavier the application, the greater degree of regenerative braking power/energy dissipation is required to minimize and/or reduce friction brake use to satisfy the emissions limits. Therefore, for commercial vehicle applications there is a chance of ageing the battery, through reliance on the battery system to support a reduction of friction brake use through regenerative braking. Therefore, a new strategy is required to protect the battery from achieving end of life prior to the expected durability requirements of the emissions legislation. Once more, a reduced battery capacity, i.e., an mHEV, is more sensitive to this. A worst-case combination could be considered as a 2-tonne commercial vehicle, which is likely to be heavily laden and/or capable of towing, with an mHEV system which is required to support regenerative braking of the heavy vehicle/friction brake emissions reduction (i.e., significant throughput required of a small capacity battery to support regenerative braking).

Moreover, in all vehicle applications (i.e., non-hybrid, hybrid and EV) if the battery is limited, either due to temperature, age, and/or charge limits generally, the battery may not be capable of supporting the regenerative braking required to maintain emissions limits. A reduced capacity battery, i.e., an mHEV battery, is more sensitive to a limited capability state. Due to the reduced capacity, it is more likely to encounter scenarios in which the battery capability may be limited and thus the regenerative braking capability will be degraded. Thus, a new strategy is required to support such a use case and to maintain friction brake particulate emissions limits.

Furthermore, an additional benefit of the disclosed embodiments that all types of vehicle may be able to achieve an increased level of vehicle speed reduction over time consistently though regenerative braking than is currently possible. This is achieved by ensuring the battery is not ‘fully charged’, i.e., to reduce or maintain the SOC of the battery, always allowing for consistent regenerative braking. Typically, to maintain below a brake light illumination threshold, a reduction in vehicle speed over time based on regenerative braking capability, with headroom, is required. Enabling more consistent regenerative braking feel, because the system is less likely to be influenced by the limited regions of battery capability to support regenerative braking, i.e., at high SOC and the regen limit could be increased to be closer to the brake light illumination threshold. Therefore, in some examples, the method comprises increasing the regenerative reduction in speed over time limit, closer to a brake light illumination threshold.

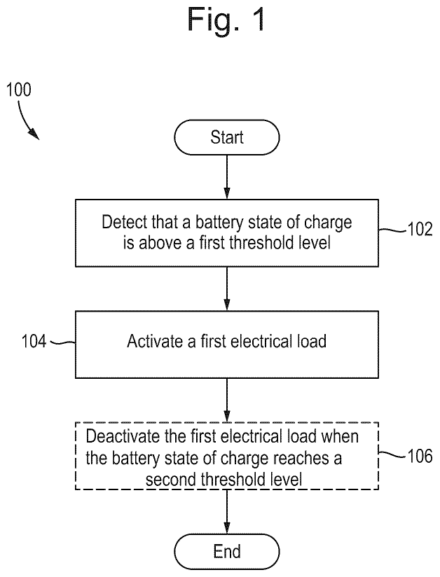

Generic methods and systems will now be described that are applicable to any vehicle application, unless stated otherwise. In particular, FIG. 1 illustrates an example flow chart of a method of controlling a regenerative braking system comprising a battery, in accordance with at least one of the examples described herein. In some examples, the activation of the regenerative braking system may be referred to as a braking event, e.g., the driver of the vehicle pressing the brake pedal, or the vehicle activating an automatic emergency braking. Process 100 starts at step 102 where the system detects that a battery state of charge is above a first threshold level. In some examples, the first threshold is a percentage charge of the battery that allows for the energy recovered from a regenerative braking event to be stored in the battery. If the battery was unable to take energy from the regenerative braking event then the friction brakes would be solely relied upon to slow down the vehicle; causing an increase in particulate matter from the friction braking system. In some examples, the difference between a first and second threshold provides capacity for an expected regenerative braking event.

At step 104, the system activates a first electrical load. In some examples, the order of the steps in FIG. 1 is for illustrative purposes and, in some examples, step 104 may precede 102. The regenerative braking system stores harvested energy from a braking event in the battery. The energy in the battery can be used to power a plurality of devices in the vehicle. For example, the vehicle system may comprise one or more electrical loads (i.e., electrical components) configured to use power from the battery, e.g., heated seats, heated windshield, electronic exhaust gas heaters, Positive Temperature Coefficient Heater, and the like. In some examples, the first electrical load is one or more of: an electronic exhaust gas heating element, a low-voltage battery system, a seat heating element, a windscreen heating element, an electronic catalyst, an air conditioning system, an air compressor, a water pump, a DC to AC external power system, or an infotainment system. In some examples, the method further comprises activating the first electrical load while the vehicle is parked, charging, or while in motion.

Optionally, process 100 may comprise step 106. At step 106, the system deactivates the first electrical load when the battery state of charge achieves a second threshold level. In some examples, the difference between the first and second threshold provides capacity for an expected regenerative braking event.

In some examples, the method further comprises activating the first electrical load in response to a user-determined charge completion time or a user-determined state of charge target. For example, the user may plug-in their PHEV (or EV) vehicle comprising a regenerative braking system and a battery, for charging overnight. It is common in modern systems to begin charging during late hours or when electricity units are cheaper to purchase according to a user configurable “leave time”. However, in the present disclosure, stored electrical energy in the battery may be discharged through an electrical load according to the user configurable leave time, to ensure that the battery has enough capacity for a regenerative braking event shortly after leaving the user's home. In some examples, this can be further tailored based on GPS or predicted navigation route data. For example, if the user lives in a particularly hilly location, a fully charged battery would almost certainly not have enough capacity for a regenerative braking event at the start of the journey. Conversely, a fully charged battery may be more appropriate if the user will be joining a motorway shortly after leaving and without passing any traffic lights.

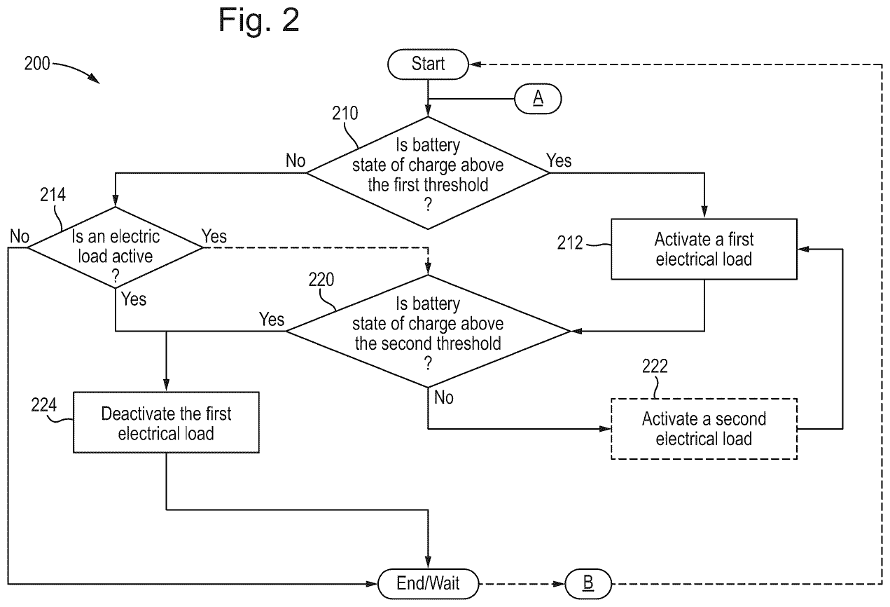

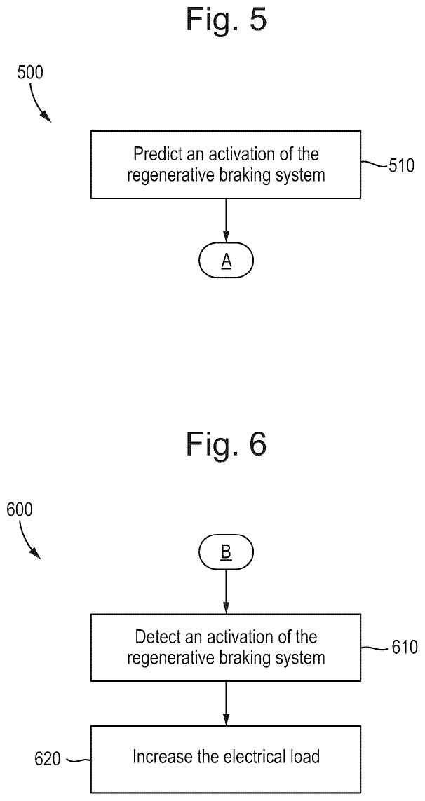

FIG. 2 illustrates an example flow chart of a method of providing heat to a catalyst of an after-treatment system, in accordance with at least one of the examples described herein. The system may be configured to carry out process 200, which starts at step 210. Process 200 is intended to show a series of decisions that may be made in relation to the methods discussed herein. Process 200 may be activated from step “A”, which follows on from process 500 in FIG. 5.

At step 210, it is determined if the battery state of charge is above the first threshold. In response to the answer to step 210 being yes, process 200 continues to step 212. At step 212, a first electrical load is activated, which is the same step as step 104 of FIG. 1. After step 210, process 200 may continue to step 220, described below. In response to the answer to step 210 being no, process 200 continues to step 214. At step 214, it is determined if an electric load is active or not. If the answer to step 214 is yes, process 200 continues on to step 224, and optionally, step 220.

At step 220, it is decided whether or not the battery state of charge is above a second threshold. If the answer to step 220 is no, step 220 optionally continues on to step 222 or returns to step 212. At step 222, a second electrical load is activated. If the answer to step 220 is yes, process 200 continues to step 224. At step 224, the first electrical load is deactivated.

If the answer to step 214 is no, or after step 224, process 200 continues on to an End/Wait. At the End/Wait, optionally, a waiting period is initiated before process 200 repeats or process 200 ends. If process 200 does repeat, an intermediate process 600 may be activated, as represented by step “B”, as described more in FIG. 6.

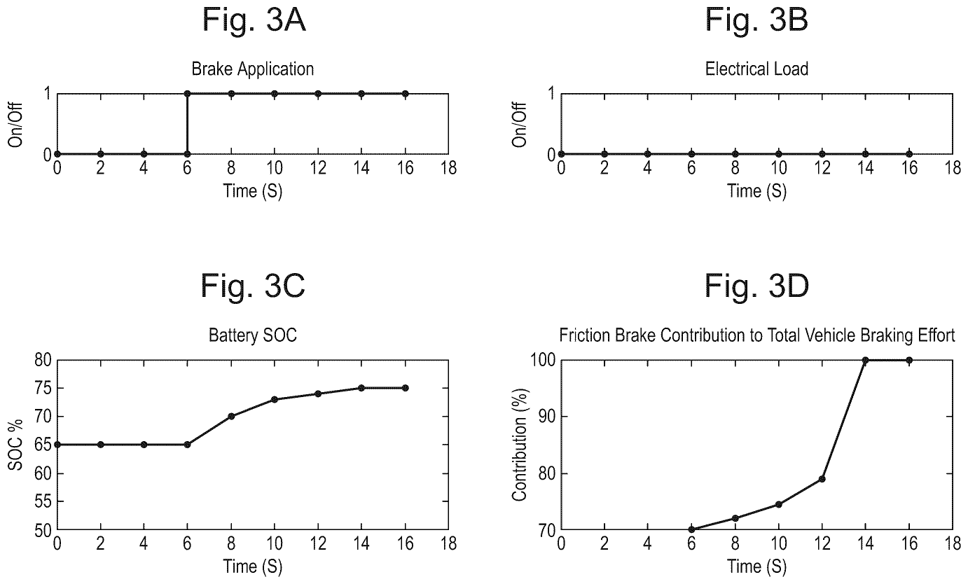

FIGS. 3A to 3D illustrate brake application and the resulting electric load and battery state of charge without the teachings of the present disclosure, in accordance with at least one of the examples described herein. In particular, FIGS. 3A to 3D consider the scenario of an mHEV travelling downhill, when the driver applies the brakes causing the hybrid system to create a regenerative braking event, applying negative torque (i.e., the vehicle's e-machine resisting the powertrain) to generate electrical energy. In such a scenario, the mHEV battery is relatively small, in terms of capacity, and can ‘fill up’ quickly, especially with a large/heavy commercial vehicle application (which would have a high inertia due to a heavy payload). FIGS. 3A to 3D do not apply the present teachings.

This is shown in FIG. 3A, which illustrates that at 6 seconds, the driver applies the brakes of the vehicle. FIG. 3A, simply shows an “on/off” value for braking, and the force applied to the brake pedal is not considered in this scenario, however, can be considered to further improve, by applying more regenerative braking (i.e., negative torque with the e-machine) based on application of the brake pedal.

FIG. 3B illustrates that no electrical load is applied during the duration of the braking event. FIG. 3C illustrates the battery charge rate reduces as the battery reaches the upper state of charge (SOC) limit, thus more braking power is required from the friction brakes during the 12-16 second interval. Battery charging is clipped to protect the battery at high State of Charge (SOC). Therefore, a greater contribution to the total vehicle braking force is required from the friction brakes, resulting in wear and emissions that are undesirable for future regulation. For completeness, FIG. 3D further illustrates the latter point as the friction brakes are required to provide the total braking effort once the battery achieves its maximum SOC (in the 12-16 seconds interval). Friction brake wear and emissions are significant.

The values that are shown in FIGS. 3A-3D are for illustrative purposes. It should be understood that many other variables affect the battery state of charge, brake application, electrical load, and friction brake contribution; so the illustrative numerical values may be higher or lower. However, these values have been generated to further illustrate the advantages and benefits of the present disclosure. In some examples, combinations of one or more of the examples disclosed herein may further improve the benefit gained.

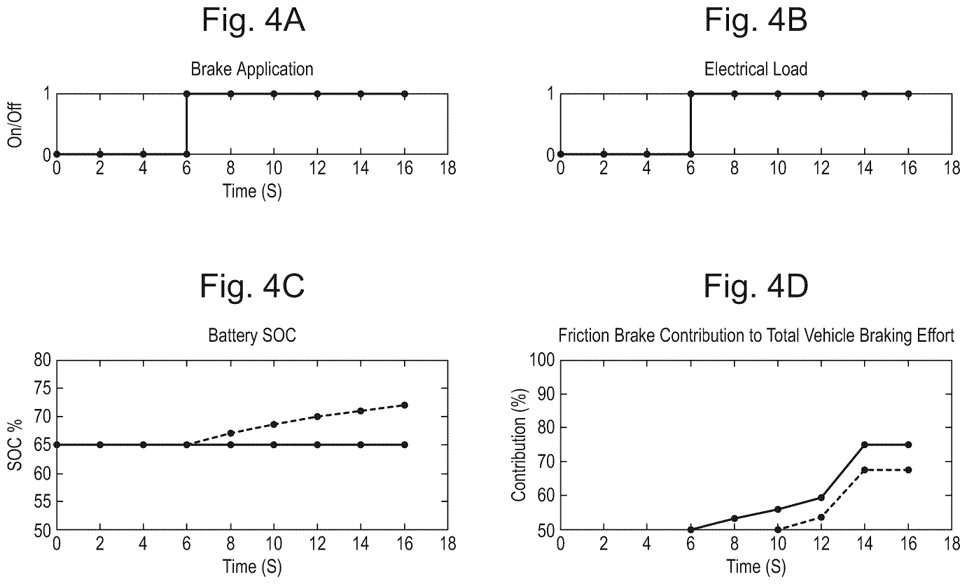

FIGS. 4A to 4D illustrate brake application and the resulting electric load and battery state of charge with the teachings of the present disclosure, in accordance with at least one of the examples described herein. Similar to FIGS. 3A to 3D, and so that a comparison can be made, FIGS. 4A to 4D consider the scenario of a mildly hybrid vehicle (mHEV) travelling downhill. In a similar way, the driver applies the brakes causing the hybrid system to create a regenerative braking event, applying negative torque (i.e., the vehicle's e-machine resisting the powertrain and driveline) to generate electrical energy. Again, in such a scenario, the mHEV battery is relatively small, in terms of capacity, and can ‘fill up’ quickly, especially with a large/heavy commercial vehicle application (which would have a high inertia due to a heavy payload). However, FIGS. 4A to 4D do apply the present teachings.

In particular, FIG. 4A illustrates that at 6 seconds, the driver applies the brakes of the vehicle. FIG. 4A, simply shows an “on/off” value for braking. In particular, FIG. 4B illustrates at the same time the braking is requested by the driver at 6 seconds (or an infinitesimally margin thereafter) an electric load is activated. In some examples, the energy consumed by the electrical loads activated is equivalent to the energy generated by the regenerative braking event, and therefore the battery is not charged during the regenerative braking event (as per the solid line of 4C). While, in some examples, the energy consumed by the electrical loads is less than the energy generated by the regenerative braking event and therefore the battery will be required to accept charge (as per the dashed line of 4C), to maintain vehicle speed reduction. However, battery charging is less with the proposed method than would otherwise be required (as per graph 3C). In both scenarios the battery throughput is reduced when compared to a typical vehicle without the present disclosure.

FIG. 4C illustrates that, using the disclosed solutions the electric loads consume the generated energy. Depending on the vehicle application (e.g., mass, system capability and degree of electrification) and the electrical loads, the battery SOC could be maintained to minimise throughput and ageing. This is achieved by the recuperated energy from the vehicle regenerative braking system being consumed directly by the electrical loads without being stored in the battery. Accordingly, in some examples, the regenerative braking system need not even be electrically coupled to the battery or batteries of the vehicle, any excess energy can be simply consumed upon activation of the regenerative braking system by the one or more electrical loads of the vehicle. This is why the throughput us reduced as the battery is not charged. In some examples, the rate of discharge from the battery is equivalent to the rate of energy consumption by the electrical loads from the regenerative braking event. Here, it is shown that an alternative way to consume energy, other than storage in the battery, can be made with the correct control strategy, and at the same time maintain regenerative braking performance.

With the present disclosure, the negative torque applied by the e-machine during the regenerative braking event can be maintained and the likelihood that the e-machine torque needs to be reduced is minimised. In some examples, the regenerated energy by the e-machine can be consumed by the electrical loads, bypassing the battery, as shown by the solid line which illustrates a constant battery SOC. Or, if the energy recuperated during the regenerative braking event is greater than the electrical loads activated, the battery will accept some charge and its SOC will increase as shown by the dashed line. However, it should be noted that this is to a lesser extent than FIG. 3C, i.e., the SOC does not achieve its maximum capacity, thus vehicle speed reduction is maintained and battery throughput is still reduced in this use case through the proposed solution. In a conventional system, adding in negative torque from the e-machine would increase the battery SOC until the battery charge was full and then the e-machine torque application would have to be reduced, increasing brake particulate emissions as the braking force is maintained by the friction brakes. However, in the present system, the level of negative torque applied can be maintained (or even increased) as one or more electrical loads are activated upon detection of, or indeed in anticipation of, a regenerative braking event (i.e., e-machine activation). This additional energy consumption, which would otherwise be stored in the battery, enabling the SOC to be managed to prevent the clipping or reduction of negative torque application. Increasing or preventing the reduction in negative torque from the e-machine equivalently reduces the amount of particulate emission from the friction brakes, as shown in FIG. 4D.

In some examples, the recuperated energy may be consumed by the eEGH alone. In some other examples, for instance where the amount of recuperated energy may be expected to be high or sustained for a large period of time (i.e., vehicle travelling substantially downhill) the battery can be preconditioned to maintain negative torque application via the e-machine to minimise particulate emissions from the friction brake system.

For completeness, FIG. 4D illustrates the friction brake usage is reduced, minimising emissions. As described above, the calibration can either maintain the battery SOC to reduce battery throughput or increase the SOC if required to maintain the negative torque applied by the e-machine, minimising the friction brake system effort.

Specifically, examples of load deployment and control to be synchronised with regenerative braking events include: deploying aforementioned strategies during vehicle speed reduction events in which regenerative braking is utilized. Deploying the eEGH during ‘Compression Braking’ during coast down, e.g., when there is no brake pedal input/request from driver. In this use case, regenerative braking is utilized despite no pedal input. During a long decent, the aftertreatment temperature is likely to reduce due to reduced engine load, therefore deploying the eEGH will not only contribute to vehicle speed reduction, but also will support tailpipe emission requirements. This also applies during coast down and braking events, the any electrical loads may be activated irrespective of brake pedal input. Moreover, typical regenerative braking use cases in which the driver applies force/input to the brake pedal, as described above with reference to FIGS. 3A-3D and 4A-4D.

Furthermore, in some examples, the user may employ a driving mode, for example, a single pedal driving mode. When the user selects a one pedal drive mode, the control strategy may be altered to account for the different use case as releasing the pressure from the pedal increases the regenerative braking. That is to say that the ‘brake pedal’ is not actually pressed or applied, the acceleration and regenerative braking effort is based on the position of a single pedal (in one pedal drive only one pedal is used). Accordingly, in some examples, during a single pedal driving mode, the activating of a first or second electrical load may be based on the angle or pressure applied to the pedal. For example, if the user lifts the pedal beyond a certain limit the regenerative braking will be activated, prior to this limit, the system will activate a first electrical load in anticipation of the energy harvested by the regenerative braking.

Some of the electrical loads that can be activated (and therefore synchronised and controlled) include the low voltage (e.g., 12V) loads, prioritizing those which the customer may not be aware of, i.e., heated seats, heated windshield, increase charge set point on low voltage (e.g., 12V) battery to replenish low voltage battery store. In addition, high voltage (e.g., 48V) loads can be deployed and/or activated, such as, charging the traction battery, e.g., a 48V or HV battery if applicable; discharge of the traction battery, e.g., a 48V or HV battery if applicable in preparation for the next regeneration event; activate heater systems, including a Positive Temperature Coefficient heater (which spend energy heating water, for example); activate other ≥48V loads, such as an electric compressor, electric water pump, DCAC for external power systems, and the like.

The values that are shown in FIGS. 4A-4D are for illustrative purposes. It should be understood that many other variables affect the battery state of charge, brake application, electrical load, and friction brake contribution; so the illustrative numerical values may be higher or lower. However, these values have been generated to further illustrate the advantages and benefits of the present disclosure. In some examples, combinations of one or more of the examples disclosed herein may further improve the benefit gained.

FIG. 5 illustrates an example flow chart of a method of predicting an activation of the regenerative braking system, in accordance with at least one of the examples described herein. Process 500 starts at step 510. At step 510, the system predicts a regenerative braking event of the vehicle. In some examples, the prediction is based on one or more of: vehicle data; navigation data; GPS data; ADAS; traffic sign recognition; cruise control system; driver inputs; or historic route information. For example, it may be determined that speed of the vehicle will remain constant, because the user is on a motorway at cruising speed with no traffic. However, a braking event is likely shortly thereafter due to the user's navigation data indication they should exit at the next junction, therefore, activating an electrical load to remove energy from the battery in order to ensure the energy recovered via the regenerative braking can be stored in the battery.

In some examples, the predicting is further based on a driving mode of the vehicle. The driving mode being one of electric propulsion; combustion engine propulsion; or a combination thereof, e.g., a hybrid power unit. For example, the capacity of a battery in a hybrid commercial electric vehicle is likely to be significantly larger, and therefore has the capability to harvest the total energy from a regenerative braking event, than that of a typical mHEV, for example. Accordingly, the control strategy may be based on the driving mode of the vehicle. In practice, this will likely result in a higher threshold (i.e., a higher % SOC) before the activation of an electrical load is made to ensure there is enough spare capacity in the battery for a regenerative braking event. For example, the engine start-up procedure may be altered based on one or more of such contextual factors. After step 510, process 500 can activate process 100 as described with reference to FIG. 1, as shown via step A which leads to step A on FIG. 1.

FIG. 6 illustrates an example flow chart of a method of actions to be taken when an activation of the regenerative braking system is detected, in accordance with at least one of the examples described herein. Process 600 starts at step 610, at reference “B” as described with reference to FIG. 2. At step 610 the system detects an activation of the regenerative braking system. At step 620, the system, in response to detecting activation of the regenerative braking system, increases the electrical load.

In some examples, increasing the amount of electrical load comprises activating a second electrical load. In some examples, the first and second electrical load are activated at the same time. In some examples, the second electrical load is one or more of: a first motor, or a second motor with a lower power output than the first motor, an electronic exhaust gas heating element, a DC to AC external power system, a low-voltage battery system, a seat heating element, a windscreen heating element, an air conditioning system, an air compressor, a water pump, a Positive Temperature Coefficient Heater, or an infotainment system.

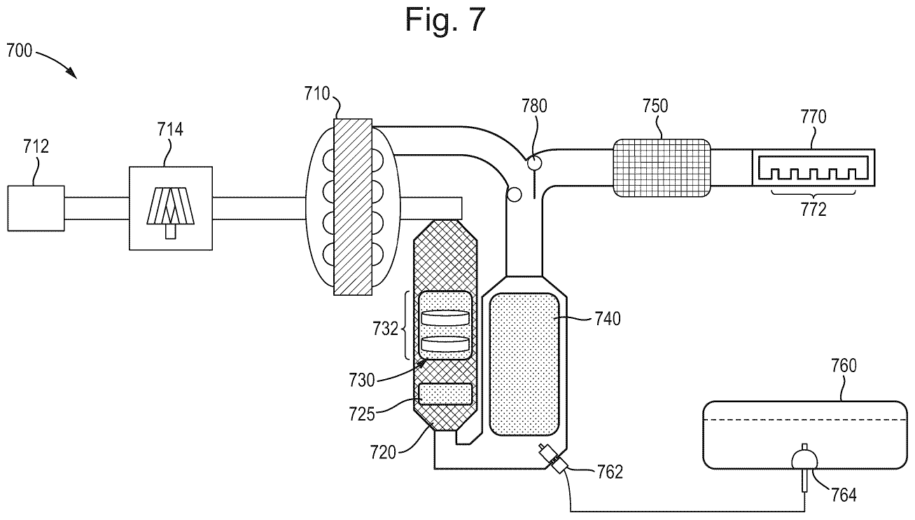

One solution to reduce the toxic emissions of vehicles is the use of an exhaust after-treatment system. Exhaust after-treatment systems aim to reduce hydrocarbons, carbon monoxide, nitrous oxide, particulate matter, sulfur oxide, and volatile organic compounds such as chlorofluorocarbons. Examples of exhaust after-treatment systems include air injection (or secondary air injection), exhaust gas recirculation, and catalytic converters. An exemplary exhaust after-treatment system is described with reference to FIG. 7.

FIG. 7 illustrates an exemplary exhaust system comprising an after-treatment system, in accordance with at least one of the examples described herein. An after-treatment system such as the one depicted comprises some electrical load components that can be activated to not only deploy energy from the vehicle battery, but also have additional benefits. For example, as shown in FIG. 7, an exemplary exhaust system 700 from a vehicle such as a hybrid vehicle may comprise an engine 710 and an after-treatment system, which comprise an electronic exhaust gas heater (eEGH) 720. In some examples, the eEGH 720 comprises a catalyst 725 that is provided heat by a plurality of heating elements 732, powered by the battery of the vehicle.

In some examples, and as shown in FIG. 7, there is provided with an air-box 712 connected to a compressor 714 to draw air from the atmosphere. The airbox 712 and compressor 714 are fluidly connected to engine 710 and the after-treatment system to transfer thermal energy from a plurality of heating elements 732 disposed within the heating module 730 within the after-treatment system to the rest of the after-treatment system (e.g., to the catalyst 725). In some examples, to support local emissions regulations, additional systems such as an e-compressor 714 may be required.

In some examples, there is a diesel particulate filter 740 downstream of engine 710. A diesel particulate filter (DPF) is a filter that captures and stores exhaust soot, coke, and/or char, collectively referred to as particulate matter. The DPF is another form of after-treatment utilized to reduce emissions from diesel cars. DPFs have a finite capacity, the trapped particulate matter periodically has to be emptied or ‘burned off’ to regenerate the DPF, which an eEGH may also be used to assist with. This regeneration process cleanly burns off the excess particular matter deposited in the filter, reducing unwanted exhaust emissions. In some examples, the filter regeneration process may be initiated in response to predicting that there will be no increase in torque demand. For example, if the amount of particular matter within the after-treatment system is determined to be above a threshold and a regeneration process is required, the after-treatment system can wait until a prediction that no increase in torque demand will be made by the driver to regenerate the after-treatment system (e.g., the DPF). Thus, in a system such as that presently required, activating the eEGH more than other electrical loads may be favoured to ensure that the DPF is regenerated and in optimal condition.

In some examples, wherein the vehicle's internal combustion engine is fueled by gasoline, there is a gasoline particulate filter (GPF), which would replace the DPF as described above, downstream of engine 710. Similar to a DPF, a GPF a filter that captures and stores exhaust soot, coke, and/or char, collectively referred to as particulate matter. The GPF is another form of after-treatment utilized to reduce emissions from gasoline vehicles. GPFs have a finite capacity, the trapped particulate matter periodically has to be emptied or ‘burned off’ to regenerate the GPF, which an eEGH may also be used to assist with. This regeneration process cleanly burns off the excess particular matter deposited in the filter, reducing the undesired exhaust emissions. In some examples, the regeneration process may be initiated in response to predicting that there will be a braking event. For example, if the amount of particular matter within the after-treatment system is determined to be above a threshold and a regeneration process is required, the after-treatment system can wait until a prediction that a braking event will be made by the driver and then the eEGH can be activated to regenerative the after-treatment filters (e.g., the GPF). Thus, in a system such as that presently required, activating the eEGH more than other electrical loads may be favoured to ensure that the DPF is regenerated and in optimal condition.

In some examples, there is also provided a selective catalytic reduction (SCR) 750 system. An SCR is another emissions control technology system that injects a liquid-reductant agent through a special catalyst into the exhaust stream of engines, in particular diesel engines. The reductant source is usually automotive-grade urea, otherwise known as diesel exhaust fluid (DEF). The DEF sets off a chemical reaction that converts nitrogen oxides into nitrogen, water, and low amounts of carbon dioxide (CO2), which is then expelled through the vehicle tailpipe 770. The DEF may be stored in a DEF tank 760. The DEF may be distributed through several pumps and valves 762 and 764, as shown in FIG. 7. The number of pumps and valves 762 and 764 are for illustration purposes and additional pumps and valves 762 and 764 may be located throughout the exhaust and/or after-treatment system. The location of the pumps and valves 762 and 764 are similarly for illustration purposes and the location of the pumps and valves 762 and 764 can be different from that shown in FIG. 7.

In some examples, the exhaust system comprises several sensors 772 to detect the flue gas containing oxides of nitrogen (NOx) and oxides of sulphur (SOx), to ensure the final emissions are within a regulation amount. Euro 5 exhaust emission legislation and Euro 6 exhaust emission legislation, have effectively made it mandatory for DPFs, DEF, and SCRs to meet the emissions standards. However, future emission legislation, such as Euro 7, such technology alone may not be sufficient. The systems and embodiments described herein may therefore work in conjunction with DPFs, DEF, and SCRs of a vehicles' aftertreatment system (i.e., more regular activation, or the like).

In some examples, the exhaust system comprises an exhaust gas recovery system, which is enabled by an EGR switch 780. The EGR switch 780 enables some or all exhaust gas, or the thermal energy of the exhaust gas, to be recirculated through the exhaust system to further compound the heating effect of the heating elements 732 within the heating module 730.

Electrically heated catalysts, or eEGHs, are a type of catalytic converter, which have been in use for a number of years. An eEGH typically comprises a heating element disposed within, or near to, a catalyst. eEGHs are required in various use cases and will demand a power supply between 0-4 kW (0 to 4000 Watts) for example, depending on the use case. For example, the heating elements within the eEGHs will have a thermal output of 0-4 kW (0 to 4000 Watts). An eEGH typically has low inductance and therefore the power output (or thermal power output) can be changed rapidly. The eEGH produces thermal power to warm the catalyst, but consumes electrical current to produce the thermal power. The eEGH demand is supported by a hybrid powertrain electrical system in an HEV or PHEV platform. For example, in a cold start use case, the eEGH may demand its full rated power (e.g., ˜4 kW) to maintain after-treatment temperature. In some examples, the power control module (PCM) demands the eEGH rated power from the HEV system for ˜200 seconds. This load will be supported by the hybrid battery transiently until the e-machine can respond to support the load. However, in some use cases in which the e-machine can't support the total demand, the battery will need to support the eEGH power supply. Thus, in some examples, the eEGH is an ideal system to activate to reduce the battery SOC in anticipation of a regenerative braking event.

During electric only driving, without thermal energy from the engine, the optimal aftertreatment temperature would not be maintained for all use cases. Therefore, if the engine is started, the emissions requirements may be exceeded. Accordingly, the present disclosure will aid in keeping the catalyst warm with an effective preheating strategy for the PHEV or FHEV applications, by utilizing the eEGH in response to, or in anticipation of, a regenerative braking event.

The systems and methods described herein may be used to deploy electrical loads (such as heating elements 732 of the eEGH) to condition the battery SOC in anticipation of a regenerative braking event to ensure capacity is available to harvest the generated electricity from the negative torque applied by the e-machine during braking. Additionally, if the engine needs to start due to meet driver demand, with the aftertreatment also preconditioned as a secondary effect of deploying electrical loads such as the eEGH, the engine can start within the EU7 emissions legislation.

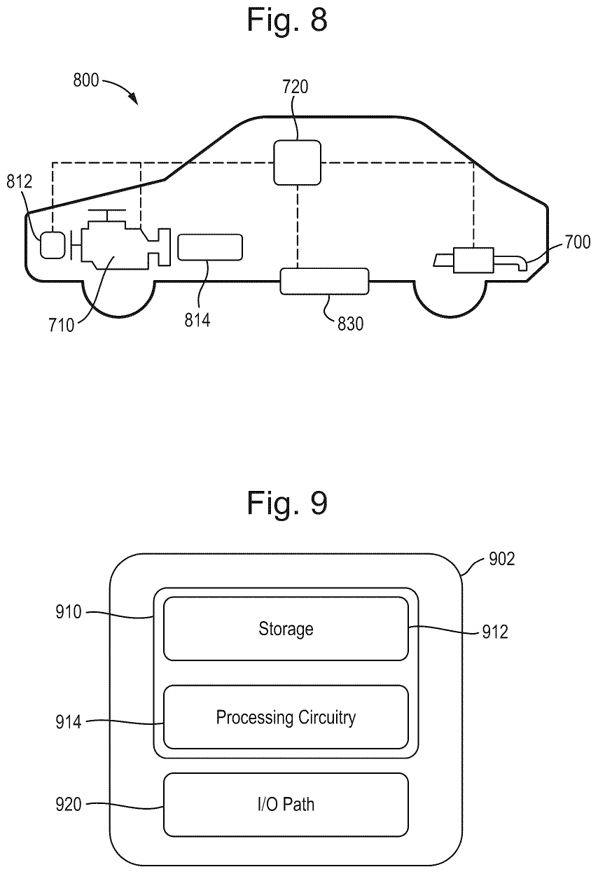

FIG. 8 illustrates a vehicle comprising an engine and an exemplary exhaust system, in accordance with at least one of the examples described herein. FIG. 8 illustrates a vehicle 800 comprising an engine 710, an exemplary exhaust system 700, a control module 820, and a battery 830, in accordance with at least one of the examples described herein. According to some examples, there is provided with a vehicle 800 comprising an exhaust system 700 as described with reference to FIG. 7. In some examples, the vehicle further comprises a drive train comprising an e-machine 812, an engine 710, clutch and transmission 814.

The methods described above may be implemented on vehicle 800. Each of the systems in the vehicle are communicatively coupled via controller 820 (illustrated by the dashed line connectors) However, the present disclosure is not limited to the set-up shown in FIG. 8. For example, the controller 820 may be any appropriate type of controller, such as a stand-alone controller, or any other appropriate controller of the hybrid vehicle. For example, the controller 820 may, at least in part, be integrated with another controller of the vehicle. Furthermore, the controller 820 may be configured to operationally communicate with any one or more of the vehicle components shown in FIGS. 7-8, and/or any other appropriate components of the vehicle. For example, controller 820 may be a stand-alone controller at least partially configured to operationally communicate with at least one low voltage accessory, an electric generator, and an eEGH, to control torque demand on the engine 710. Furthermore, it is understood that controller 820 may be configured to carry out one or more of the above-disclosed electrical power control methods for a hybrid vehicle, as described above.

Accordingly, with less cycling of the battery over the expected lifetime of the vehicle, the proposed solutions enable a reduction in the degradation or ageing in battery life, without the need to increase the battery capacity and therefore price. Advantages of the present disclosure are clear and have been described throughout.

FIG. 9 illustrates a block diagram of a computing module, in accordance with some embodiments of the disclosure. In some examples, computing module 902 may be communicatively connected to a user interface. In some examples, computing module 902, may be the controller 820 of the vehicle 800 as described with FIG. 8. In some examples, computing module 902 may include processing circuitry, control circuitry, and storage (e.g., RAM (Random Access Memory), ROM (Read Only Memory), hard disk, a removable disk, etc.). Computing module 902 may include an input/output path 1206. I/O path 920 may provide device information, or other data, over a local area network (LAN) or wide area network (WAN), and/or other content and data to control circuitry 910, which includes processing circuitry 914 and storage 912. Control circuitry 910 may be used to send and receive commands, requests, signals (digital and analogue), and other suitable data using I/O path 920. I/O path 920 may connect control circuitry 910 (and specifically processing circuitry 914) to one or more communications paths. In some examples, computing module 902 may be an on-board computer of a vehicle, such as vehicle 800.

Control circuitry 910 may be based on any suitable processing circuitry such as processing circuitry 914. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some examples, processing circuitry may be distributed across multiple separate processors or processing units, for example, multiple of the same type of processing units (e.g. two Intel Core i7 processors) or multiple different processors (e.g., an Intel Core i5 processor and an Intel Core i7 processor). In some examples, control circuitry 914 executes instructions for computing module 902 stored in memory (e.g., storage 912).

The memory may be an electronic storage device provided as storage 912, which is part of control circuitry 910. As referred to herein, the phrase “electronic storage device” or “storage device” should be understood to mean any device for storing electronic data, computer software, or firmware, such as random-access memory, read-only memory, hard drives, solid-state devices, quantum storage devices, or any other suitable fixed or removable storage devices, and/or any combination of the same. Non-volatile memory may also be used (e.g., to launch a boot-up routine and other instructions). Storage 912 may be sub-divided into different spaces such as kernel space and user space. Kernel space is a portion of memory or storage that is, e.g., reserved for running a privileged operating system kernel, kernel extensions, and most device drivers. User space may be considered an area of memory or storage where application software generally executes and is kept separate from kernel space so as to not interfere with system-vital processes. Kernel mode may be considered as a mode when control circuitry 910 has permission to operate on data in kernel space, while applications running in user mode must request control circuitry 910 to perform tasks in kernel mode on its behalf.

Computing module 902 may be coupled to a communications network. The communication network may be one or more networks including the Internet, a mobile phone network, mobile voice or data network (e.g., a 3G, 4G, 5G or LTE network), mesh network, peer-to-peer network, cable network, cable reception (e.g., coaxial), microwave link, DSL (Digital Subscriber Line) reception, cable internet reception, fiber reception, over-the-air infrastructure or other types of communications network or combinations of communications networks. Computing module 902 may be coupled to a secondary communication network (e.g., Bluetooth, Near Field Communication, service provider proprietary networks, or wired connection) to the selected device for generation for playback. Paths may separately or together include one or more communications paths, such as a satellite path, a fiber-optic path, a cable path, a path that supports Internet communications, free-space connections (e.g., for broadcast or other wireless signals), or any other suitable wired or wireless communications path or combination of such paths.

In some examples, the control circuitry 910 is configured to carry out any of the methods as described herein. For example, storage 912 may be a non-transitory computer-readable medium having instructions encoded thereon, to be carried out by processing circuitry 914, which cause control circuitry 910 to carry out a method of controlling a regenerative braking system comprising a battery. The method comprising detecting that the battery state of charge is above a first threshold level; and activating a first electrical load prior to activation of the regenerative braking system to reduce the battery state of charge below the first threshold level.

It should be understood that the examples described above are not mutually exclusive with any of the other examples described with reference to FIGS. 1-9. The order of the description of any examples is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

Other variations to the disclosed embodiments can be understood and effected by those skilled in the art in practicing the claimed disclosure, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

This disclosure is made to illustrate the general principles of the systems and processes discussed above and is intended to be illustrative rather than limiting. More generally, the above disclosure is meant to be exemplary and not limiting and the scope of the disclosure is best determined by reference to the appended claims. In other words, only the claims that follow are meant to set bounds as to what the present disclosure includes.

While the present disclosure is described with reference to particular example applications, it shall be appreciated that the disclosure is not limited thereto. It will be apparent to those skilled in the art that various modifications and improvements may be made without departing from the scope and spirit of the present disclosure. Those skilled in the art would appreciate that the actions of the processes discussed herein may be omitted, modified, combined, and/or rearranged, and any additional actions may be performed without departing from the scope of the disclosure.

Any system feature as described herein may also be provided as a method feature and vice versa. As used herein, means plus function features may be expressed alternatively in terms of their corresponding structure. It shall be further appreciated that the systems and/or methods described above may be applied to, or used in accordance with, other systems and/or methods.

Any feature in one aspect may be applied to other aspects, in any appropriate combination. In particular, method aspects may be applied to system aspects, and vice versa. Furthermore, any, some, and/or all features in one aspect can be applied to any, some, and/or all features in any other aspect, in any appropriate combination. It should also be appreciated that particular combinations of the various features described and defined in any aspect can be implemented and/or supplied and/or used independently.

1. A method of controlling a regenerative braking system of a vehicle, the method comprising:
detecting a regenerative braking event of the vehicle; and
activating a first electrical load to consume energy from the regenerative braking event.

2. The method of claim 1, wherein the vehicle comprises a battery, the method comprising:
detecting a surplus of energy from the regenerative braking event; and
storing the surplus energy in the battery.

3. The method of claim 2, further comprising:
after the regenerative braking event, reactivating the first electrical load to consume energy from the battery.

4. The method of claim 2, further comprising:
detecting that the battery state of charge is above a first threshold level; and
activating the first electrical load prior to activation of the regenerative braking system to reduce the battery state of charge below the first threshold level.

5. The method of claim 4, further comprising:
detecting a trigger event to activate the first electrical load prior to activation of the regenerative braking system;
wherein the trigger event is one or more of a smart phone application used to wake up the vehicle, the detection of a key in proximity, or based on the anticipated start of a trip from prior user data, or a predetermined set time.

6. The method of claim 4, further comprising:
deactivating the first electrical load when the battery state of charge reaches a second threshold level, the second threshold level lower than the first threshold level.

7. The method of claim 6, wherein the difference between the first and second threshold provides capacity for an expected regenerative braking event.

8. The method of claim 1, wherein the first electrical load is one or more of: a low-voltage battery system, a seat heating element, a windscreen heating element, an electronic exhaust gas heating element, an electronic catalyst, an air conditioning system, an air compressor, a water pump, a DC to AC external power system, a Positive Temperature Coefficient Heater, or an infotainment system.

9. The method of claim 1, further comprising, in response to detecting activation of the regenerative braking system, increasing the electrical load.

10. The method of claim 9, wherein increasing the amount of electrical load comprises activating a second electrical load.

11. The method of claim 10, wherein the first and second electrical load are activated at the same time.

12. The method of claim 9, wherein the second electrical load is one or more of: a first motor, or a second motor with a lower power output than the first motor, an electronic exhaust gas heating element, a low-voltage battery system, a seat heating element, a windscreen heating element, an electronic catalyst, an air conditioning system, an air compressor, a water pump, a DC to AC external power system, a positive temperature coefficient heater, or an infotainment system.

13. The method of claim 1, further comprising activating the first electrical load while the vehicle is parked, charging, or in motion.

14. The method of claim 2, further comprising activating the first electrical load in response to a user-determined charge profile.

15. The method of claim 1, further comprising predicting an activation of the regenerative braking system.

16. The method of claim 15, wherein the prediction is based on one or more of: vehicle data; navigation data; GPS data; ADAS; traffic sign recognition; cruise control system; driver inputs; or historic route information.

17. The method of claim 15, wherein:
the predicting is further based on a driving mode of the vehicle; and
the driving mode is one of electric propulsion; combustion engine propulsion; one pedal driving operation; or a combination thereof.

18. A regenerative braking system of a vehicle comprising:
a first electrical load electrically coupled to the regenerative braking system;
control circuitry communicatively coupled to the first electrical load and the regenerative braking system, the control circuitry configured to:
detect a regenerative braking event of the vehicle; and
activate the first electrical to consume energy from the regenerative braking event.

19. A vehicle comprising the regenerative braking system of claim 18.

20. A non-transitory computer-readable medium having instructions encoded thereon for carrying out the method of claim 1.
